(19) United States
(12) Patent Application Publication
(10) Pub. No.: US 2002/0128923 A1
(43) Pub. Date: Sep. 12, 2002

(54) System and method for utilizing an internet enabled telephone to conduct business

(76) Inventor: Shaun Dale, Los Angeles, CA (US)

Correspondence Address: OPPENHEIMER WOLFF & DONNELLY LLP, 2029 CENTURY PARK EAST, 38TH FLOOR, LOS ANGELES, CA, 90067-3024, US

(21) Appl. No.: 09/992,270

(22) Filed: Nov. 14, 2001

Related U.S. Application Data
(60) Provisional application No. 60/248,915, filed on Nov. 14, 2000.

(51) Int. Cl. G06F 17/60

(52) U.S. Cl. 705/26

(57) ABSTRACT

A method of utilizing internet gears (Iphone(s)) is described. Iphone(s) may be configured to receive (and, if coupled to a camera, recognize), and advertising media may be configured to transmit, URLs and Account Names (URL(s)). These URL(s) can be assigned, for example: (1) to a vehicle by license number, (2) to each commodity in a retail store, (3) to individual persons and to the like, thereby allowing another person to access the corresponding web sites anonymously. These same features can also allow businesses to rent unused space to flea marketers for marketing their goods and services, and deliveries thereof on demand. Online communities of common interest groups may effectively utilize this method in fractal fashion A w_w.MblCam.Com community may provide online shooting services involving iphone-camera owners, photographer(s) and media group(s). URL(s) and email addresses may be used as advertising vehicles for patronizing customers.

The present application claims priority to U.S. Provisional Patent Application No. 60/248,915 filed Nov. 14, 2000, which is incorporated by reference into the present disclosure.

### BACKGROUND OF THE INVENTION

1. Field of the Invention

The present invention relates to a computer method and system for advertising, marketing and acquiring members for an organization and for goods and services, and more particularly, to a method and system that utilizes the Internet to advertise for and recruit members into an organization and for their goods and services.

2. General Background and State of the Art

The Internet comprises a vast number of computers and computer networks that are interconnected through communication links. The interconnected computers exchange information using various services, such as electronic mail and the worldwide web. The worldwide web allows a server computer system, such as a web server or web site, to send graphical web pages of information to a remote client computer system. The remote client computer system can then display the web pages.

To view a specific web page, a client computer system specifies a uniform resource locator (“URL”) and/or URL and Account Name therewith (“URL(s)”) for a particular web page in a request. The request is forwarded to the web server that supports that web page. When that web server receives a request, the server sends signals through the Internet or network to the client system.

These signals, when received by the client system, are interpreted by the software and hardware of the client system to produce web pages which are then displayed by the client system to the user. When the client computer system receives the web page, it typically displays the web page using a browser. A browser is a special-purpose software application program that affects the requesting and displaying of web pages on the client system. The worldwide web is especially conducive to conducting electronic commerce. Many web servers have been developed through which senders can advertise and sell products. The products may include items, such as music or movies that are delivered electronically to the purchaser over the Internet.

The products available may also include other items, such as books, that are delivered to a purchaser through conventional distribution channels. A server computer system may also provide an electronic version of a catalog that lists the items that are available for purchase. A potential purchaser using the system may browse through the catalog using a browser and select various items for purchase. When the potential purchaser has completed selecting the items to be purchased the server computer system then prompts the user for information needed by the server to complete the ordering of the items. This purchaser-specific order information may include the purchasers name, credit card number and shipping address for the order. The server computer system then typically confirms the order by sending a confirming web page or email to the client computer system, and then schedules shipment of the items.

Recently, Internet Ready mobile gears such as PDAs, Internet ready mobile telephones and the like (hereinafter called “iphone” or “iphone(s)”) have become available which are capable of connecting to the Internet using some form of radio transmission. The Internet ready telephone or iphone(s) also includes software, such as a browser, that can display web pages of web sites accessed from the Internet on the Internet ready telephone. Because the display on the Internet ready telephone is relatively small and is capable of displaying less information than the typical display screen attached to a desktop or laptop computer, the contents of web pages transmitted to the telephone typically must be transformed into a format suitable for the display of the Internet ready telephone or iphone(s).

With the advent of the Internet ready telephone, an entire new area of electronic commerce has become available. In order to fully utilize the iphone(s)'s Internet features, the human interface for inputting lengthy URL(s) and/or email addresses must be improved.

Presently, the best of all the interfaces of the prior art seems to be a voice-activated input approach; however, if confidentiality is required, this approach is generally unsatisfactory. What has been needed, therefore, and heretofore unavailable, is a system and method of automatic input of URL(s) and email addresses into iphone(s) without communicating this fact to other persons.

Furthermore, many advertising media such as signs and billboards have recently begun advertising URL(s); however, none of them are capable of transmitting such URL(s) to iphone(s). What is needed, therefore, and heretofore unavailable, is a system and method and/or apparatus that can transmit URL(s) to iphone(s) in the vicinity.

Furthermore, there are many iphone(s) with cameras (hereinafter referred to as “iphone-camera”) now on the market; however, none of them are capable of recognizing URL(s) posted on the media or to things such as signs, billboards, badges, t-shirts, etc. What has been needed, therefore, and heretofore unavailable, is a system, method and/or apparatus that can recognize indicated patterns of URL(s) (whether printed or embossed) and store this data into iphone(s) from whence it can be used to access the said URL(s) on demand.

Previously, URL(s) have been assigned only to humans or entities operated by humans and not to a thing or a commodity (such as to a vehicle), nor to an animal, fish, plant or the like. What has been needed, and heretofore unavailable, is a system and method to effectively and productively utilize such assignment of URL(s) to other species, and inanimate objects and the like.

Furthermore, previously, web sites have been mostly utilized by and between remote parties but not so much by and between parties in close proximity or face-to-face. What has been needed, and heretofore unavailable, therefore, is a system and method to utilize web sites not only in remote fashion but also by and between the parties in close proximity and/or face-to-face.

Furthermore, previously, various online communication features have been provided over the Internet, such as chatting, online conferences etc., but they do not provide a written record for the parties involved of their business negotiations sufficient to constitute proof of same for legal purposes. What has been needed, and heretofore unavailable, is a system and method to allow online negotiations to be conducted explicitly starting from a process of offer and acceptance to a consummation of a deal, record all the processes just like an answering device or recording device and provide a written record of those negotiations to the parties concerned upon request.

Furthermore, previously, some sort of a promotional method allowing the pay out of cash prizes and the like has been employed over the Internet in remote fashion but has never been used by and between persons in close proximity or interacting face-to-face. What has been needed therefore, and heretofore unavailable, is a system and method to allow real time drawing for cash prizes and the like and immediate pay out thereof to be conducted by and between persons and/or entities in close proximity and/or interacting face-to-face.

Furthermore, previously, in order for anyone to start one's own shop even on a small scale, it has been necessary to invest a minimum of at least a few thousand dollars and to fund monthly fixed expenses of at least a few hundred dollars for rent, overhead, etc., with one's full-time devotion to the business. Therefore, many people who lack resources or time to devote themselves fully to the business have been unable to start up new ventures. What has been needed therefore, and heretofore unavailable, is a system and method that allow these entrepreneurs to try out their own shops with a minimal initial investment and minimal monthly fixed expenses and without requiring their full-time devotion.

Previously, many businesses have lacked the means to utilize their unused capacity or space productively. For example, many airlines are flying without full passengers, and many hotels operate with some empty rooms. Similarly, many restaurants are closed during off peak hours. Parking lots of many shopping centers have not been utilized after hours. Most real estate for business purposes has not been utilized in night time (or, in other instances, day time). What has been needed therefore, and heretofore unavailable, is a system and method to utilize these unused capacities for alternative use, thereby turning them into valued assets.

Previously, the typical method utilized by Internet Service Providers (“ISP”) for generating business on the Internet included providing a web server hosting a number of web sites advertising various providers goods or services. The web sites typically provide a user accessing those web sites with online advertising or catalogs of goods or services provided by the web site owner.

Previously, the operator of the web server or ISP for such web sites typically charges the owner of the web site a substantial fee for hosting the web site. This fee may take various forms, such as monetary payments that are either for a fixed amount, or some amount that is a function of the amount of the actual sales of goods or services advertised on the web site.

Recently, many server operators or ISPs have begun offering free web site hosting, covering expenses by requiring the web site owner to display advertising sold by the server operator on the web site owner's web page. Such free hosting services may be characterized as unfair business practices, as they disregard the cost needed to sustain such hosting service operations, similar to the unfair under-cost dumping practices usually condemned in other industries. Consequently, such unfair business practices prevent new operators from entering into the Internet Industry and competing fairly with others.

Another difficulty with the current method of performing business on the Internet is that in order for a web server to be successful, it must recruit potential web site owners to place web sites on its system. In the past, such recruitment has required a sales force whose duties included calling or visiting potential customers to explain the services offered by the server operator and to negotiate and obtain commitments from the web site owners to place a web site on the server. What has been needed, and heretofore unavailable, is a system and method for providing web sites to customers and recruiting customers for those web hosting services that does not require the use of expensive and difficult to train sales persons.

Additionally, a need exists for a method of using the Internet to allow the formation of groups of individuals or businesses that share common interests that allows marketing of services and goods, possibly including targeted discounts, to the groups.

Moreover, a need exists for carrying out business on the Internet utilizing the mobile capability of the Internet to allow for business to be carried out in a remote fashion, such as, for example, using the Internet to allow for remote professional photography or for providing a way to utilize unused capacity or resources of individuals or businesses.

The present invention satisfies these needs.

### INVENTION SUMMARY

A system and method of this invention has made it possible for persons, without devoting their time exclusively but concurrently engaging themselves in daily duties, not only to contribute to Nature Conservation through the reduction of CO² by redistributing unusable goods but also goods that are usable and of value to others (hereinafter called “FleaMaGoods”) that may otherwise be thrown away as rubbish, causing the formation of poisonous gasses and/or materials such as CO², dioxin and the like during its processing, but also to do any businesses, owing to Internet technologies, more particularly mobile Internet technologies including mobile gear such as PDAs and Internet-ready telephones (hereinafter referred to as “iphone(s) or “iphone”) and the like, which have recently become available.

In this invention, iphone(s) and the Internet may be most effectively used as in the following manner in which a URL(s) may be assigned not only to persons or entities, but also to commodities such as a vehicle and the like and advertised by either attaching a URL(s) to the assignee or the assigned goods or other things, or to something(s) in close proximity thereof, for marketing of said FleaMaGoods and immediate deliveries thereof, and/or for other interactions by and between those persons, commodities, animals and the like, especially in person or in close proximity, creating various novel methods of doing business and/or forming personal relationships, as hereinafter described.

### BRIEF DESCRIPTION OF THE DRAWINGS

The following invention will become better understood with reference to the specification, appended claims, and accompanying drawings, where:

FIG. 1 IS A PERSPECTIVE VIEW OF MY INVENTION.

FIG. 2 SHOWS A SEARCH TEMPLATE TO LOCATE A VEHICLE BY ITS LICENSE NUMBER.

FIG. 3 SHOWS A SAMPLE TEMPLATE TO ACTIVATE A BUILT-IN ONLINE NEGOTIATION FEATURE AND DOWNLOAD A PROOF-LOG THEREOF.

FIG. 4 SHOWS A SAMPLE TEMPLATE TO REGISTER A VEHICLE BY ITS LICENSE NUMBER.

FIG. 5 SHOWS A SAMPLE TEMPLATE TO UPLOAD A HOME PAGE FOR FLEA MARKETER MEMBERS.

FIG. 6 SHOWS A SAMPLE PROCESS OF A GROWING FRACTAL ORGANIZATION, A FLEAMA.COM ONLINE COMMUNITY.

### DETAILED DESCRIPTION OF THE PREFERRED EMBODIMENTS

The present invention as embodied in the exemplary drawings includes a system and method for carrying out commerce using Internet ready or capable telephones in communication with servers, web sites and other Internet ready or capable telephones. In its broadest aspect, the present invention takes advantage of the portability of Internet ready or capable telephones using cellular or other mobile technology to allow for and enhance the flow of Internet based commerce by providing a mobile remote terminal capable of displaying advertisements from merchants or providers of services.

The Internet ready or capable telephone also provides the ability to communicate with merchants and service providers having web sites accessible to the Internet ready or capable telephone to purchase goods or services from remote locations or while moving from place to place.

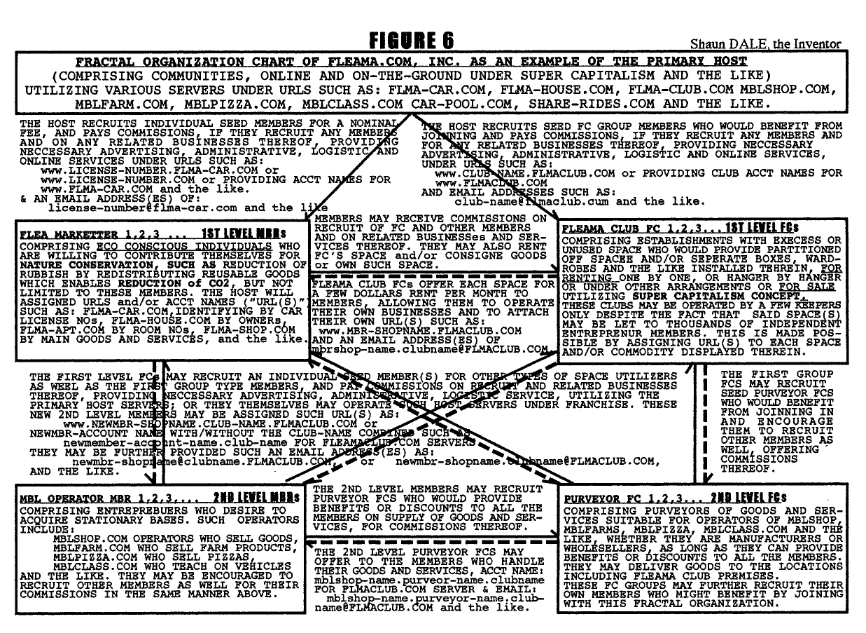

The present invention is novel in that it focuses on and links a FIRST GROUP of individuals and/or entities, hereinafter indicated as members (MBRs) who share the same norms and values and/or common interests, to a SECOND GROUP of individuals and/or businesses or entities such that mutual benefits between the groups concerned are generated. These two groups, which will also be understood to include multiple groups beyond those described above, utilizing the host server as a unit, can recursively grow in fractal fashion to a fractal organization with the help of various online features such as instant registration, upload, communication features made available by the present invention that are described below. In this context it will be understood that the host server may be an entity that provides the server hardware and software enabling the establishment of an on-line community consisting of the FIRST GROUP and the SECOND GROUP. It will also be understood that each member of the SECOND GROUP may also act as a host server, thus establishing another level of the online community which may also host MBRs and SECOND GROUP individuals, shops or business entities. This relationship may be continued through additional layers of on-line communities as illustrated in FIG. 6 to form the fractal organization described herein.

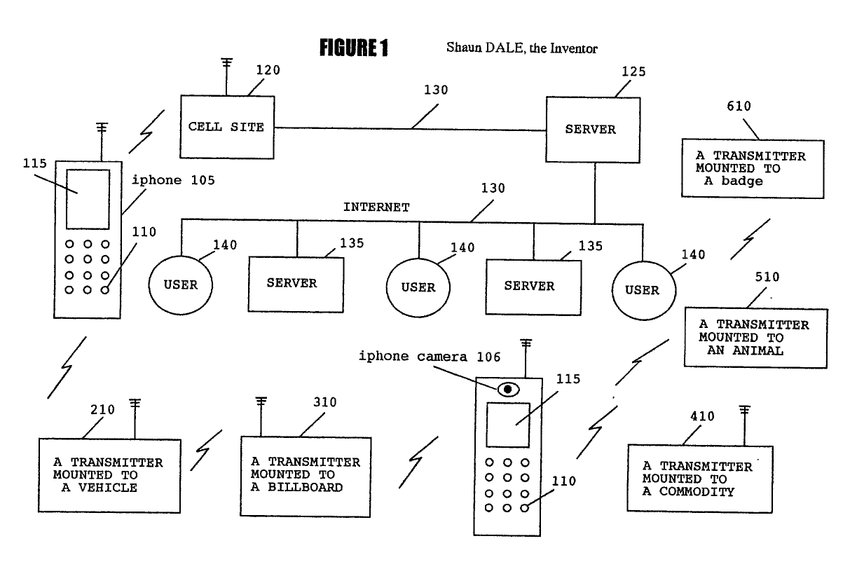

FIG. 1 is an overview of one embodiment of a computer-based system of the present invention. With this system, a user utilizes an Internet enabled telephone, or iphone 105, iphone camera 106, to communicate via radio waves or other technology, such as cellular based analog or digital technology. The iphone(s) send and receive information, which may be voice or data, to and from a centrally located site, such as a cell site. In this manner, the iphone(s) may be used from more than one location, limited only by the availability of appropriate telecommunications services.

The iphone typically includes keys or buttons 110. The keys or buttons 110 may be activated by pressing provided signals to the hardware and software of the iphone 105 to instruct the software and hardware within the iphone 105 to generate signals that are then transmitted by the iphone 105 to a system using cellular or other technology. These signals may be used in a variety of ways known in the art, such as to construct a telephone number to be called, or they may be used to request information from computer servers accessible by the telecommunication service or network. The software and hardware of the iphone 105 may also be configured to allow entry of telephone numbers or requests for information using voice recognition, thus eliminating the need to physically activate keys or buttons 110.

The iphone 105 also includes a display 115 which is used to display information to the user of the iphone 105. The display 115 may show, for example, telephone numbers to be called, displaying the digits of the telephone number as the numbers are keyed into the iphone 105 by the iphone user using keys or buttons 110. Display 115 may also display the phone number of persons calling the iphone 105. Additionally, the software and hardware of the iphone may be enabled to store names and telephone numbers of entities known to the user such that a caller may be identified by name on display 115.

Where connection with the Internet is enabled by the telecommunication service, the cell site 120 may connect with a server 125 via communication media 130. In this manner, the cell site 120 provides access to the Internet 130, which in turn provides access to other servers 135 hosting web sites and also to web sites established by other iphone users 140.

Servers 125 and 135 may include software applications running on the servers 125,135 that enable the iphone(s), through the communication system, to access web sites hosted on the servers 125,135. The system may also include software enabling text communications between two or more users of iphones 105. In this manner, the system provides a way for iphone users to communicate with each other in ways other than the voice mode used by traditional telephones. This feature allows the user of an iphone 105 to receive text messages, graphics and web site information which is then displayed on display 115 of iphone 105 while the user is on the move.

With this capability, an iphone 105 user may, for example, while driving through a city, see an advertisement for a commodity or service that includes a URL(s) for the company offering the commodity or service, and immediately enter the URL(s) into the iphone 105, using either keys or buttons 110 or by utilizing the voice recognition capability of the iphone 105 to access the web site identified by URL(s). Once the web site is accessed, the iphone user may receive additional information about the commodity or service, such as price and availability information, and negotiate a purchase of the commodity or service.

For example, the iphone 105 may be programmed to provide the web site with a digital certificate identifying the iphone user and including information allowing the iphone user's bank account to be debited for the cost of the purchased commodity or service, together with any ancillary costs, such as shipping and handling charges. The display also allows the user to receive immediate confirmation that the transaction has been completed.

Because the iphone 105 allows for immediate communication with Internet based businesses, it allows a number of new and novel methods of doing business which, while possible using a traditional business approach, could not be carried out as easily or as inexpensively as is the case using the iphone(s).

In one aspect of the present invention, a method of utilizing an iphone 105 to promote what can be characterized as a rolling flea market based in the automobile of an iphone user is described herein. In this method, an individual, who may also be operating a business out of his car, who may have various items for sale, may operate his own flea market and/or business offering various goods and services for sale.

The goods and services thus offered are not limited to small items, such as household goods, but may also include any kind of goods or services. In this method, the seller establishes a web site on a server which may include a catalog of the goods and services offered along with various information such as price, availability, transportation charges, and the like. The seller affixes a URL(s) identifying the location of his web site on his or her person or vehicle in some manner. For example, the URL(s) may be on a poster or decal that is attached to the user's vehicle, such as a license plate frame, or it may be printed on a shirt or other article of clothing worn by the seller or the seller's agent or employee. In this manner, others who happen upon the seller or the seller's automobile may observe the URL(s) of the seller's web site. If the potential purchaser possesses an iphone 105, the purchaser may enter the URL(s) of the advertisement into the iphone 105 using the keys or buttons of the iphone 105, and thus gain access to the user's web site. In this way, the purchaser may browse the goods and services offered by the user.

One disadvantage of the above described method is, however, that the URL(s) may be unwieldy and difficult to enter, especially while in motion. This disadvantage may be overcome by utilizing a novel feature of the present invention which enables broadcast, reception and recognition of the URL(s). In this embodiment, the iphone(s) may be configured to broadcast its own URL(s) and to receive URL(s)'s that are broadcast by transmitters associated with those offering goods and services for purchase.

The iphone(s) may also be equipped with a camera such as iphone camera 106 capable of capturing the URL(s) image pattern and, in conjunction with software designed to recognize the pattern, enter the URL(s) from the image into the iphone camera 106 so it can be accessed. The broadcast may be any form of broadcast communication allowed, and may use any form of electromagnet radiation or sound waves that an iphone camera 106 has been configured to receive.

The transmitter may be large or small, depending on the technology used, and may be mounted, for example, to the seller's vehicle as a transmitter 210 in FIG. 1 or to a billboard as in a transmitter 310, or to a commodity as in a transmitter 410 or to an animal as in a transmitter 510, advertising the seller's URL(s) as well as goods and services. Alternatively, the transmitter may be affixed to, for example, a badge as in a transmitter 610 and the like, held, or worn by the seller or the seller's agent or employee or the seller's belongings or the like such that any iphone(s) in the vicinity of the transmitter may receive the broadcast URL(s).

The iphone(s) may also be configured to receive and display all of the URL(s) that are being broadcast within a predetermined distance of the iphone(s). Thus, as the iphone user moves from place to place, the iphone(s) will pick up the broadcast URL(s) relatively close to the user's location.

The iphone(s) software allows the user to scan the received URL(s) and select from among the received URL(s) one or more URL(s) that may then be stored in the memory of the iphone(s).

Further, a seller's iphone(s) may be equipped to continuously broadcast the URL(s) of the sellers web site. The iphone camera(s) may also be configured to capture images of URL(s) displayed on clothing, vehicles, billboards or the like, and, using specialized software in the iphone(s), enter the URL(s) into the iphone(s) so that it can be used to access the web page identified by the URL(s). Such broadcast, reception and recognition capabilities or easy access methods are advantageous in that they eliminate the need for a potential purchaser to key in a long or complex URL(s), thus avoiding any safety concerns that may arise if the purchaser is attempting to key in the URL(s) while driving a vehicle.

Once the potential purchaser is presented with the web site, the purchaser may be interested in purchasing the advertised goods and services, but he may desire better terms and conditions than those offered by the web site. Accordingly, the web site may also be enabled to provide negotiation capabilities. The negotiation capability allows the purchaser to, for example, enter a text message, a voice message, or video message into a dedicated portion of the web site that is then communicated by software supporting such a feature to the seller through the seller's iphone(s). If the seller's iphone(s) is equipped with a camera, the buyer may request actual photo images of the goods and services. In this way, a real time negotiation link between a purchaser and a seller may be established, allowing the seller to identify himself without requiring the purchaser to identify himself, thus preserving the purchaser's anonymity. Various negotiations may take place between the seller and purchaser and the transaction may be completed between the observer and the seller utilizing only the iphone(s) system described above.

In one possible aspect of this embodiment of the present invention, the seller may maintain an inventory of goods in his vehicle. Such an inventory allows a potential purchaser of the seller's goods to meet with the seller and complete the transaction. For example, a mutually agreeable stopping place along the drivers route could be arranged as a meeting place and could be negotiated either through text messages sent through the iphone(s) of the seller and purchaser, or the seller may send a text message including the seller's iphone number to the potential purchaser, allowing the buyer to call the seller and arrange, using traditional voice communications, a mutually agreed meeting place. Alternatively, the parties may agree to meet at the seller's shop in the premise of a member of the Second Group, as defined above, who has made a portion or all of the premise available for meetings of this type or as inventory storage and/or distribution base of the seller. The premises may be made available utilizing the method described with reference to Super Capitalism below. This approach may also be used to facilitate negotiations of price, quantity, and the like between the buyer and the seller.

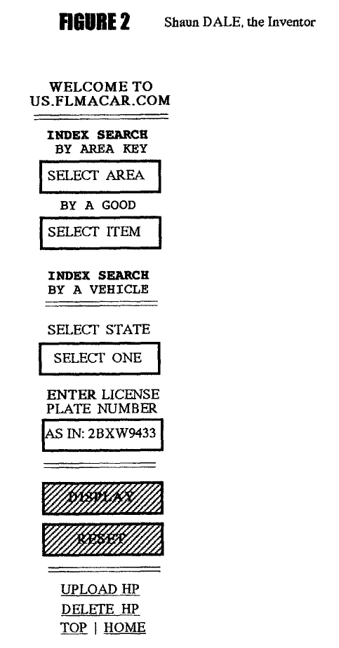

When a potential purchaser logs on to the seller's web site, for example, to use the system of the present invention, the potential purchaser may be presented with a web page similar to that illustrated in FIG. 2. In one aspect, an easy method of providing access to the web page may be to arrange or modify software running on the host server to accept the vehicle license number of the seller to be an account number for the w_w.FLMACAR.COM or the w_w.MblFleaMa.Com server(s) or to register the_seller's_car_license_number.com as the URL. Either approach may be advantageous for both the seller and the potential purchaser as these URL(s) could be imprinted on the automobiles at the factory, allowing the potential purchaser to simply enter the license plate number of the seller's car to access the seller's web site.

This entry web page, which is displayed on the display of the iphone(s), allows the potential purchaser to use the keys or buttons of his iphone(s) to enter either the advertised URL(s) or, in another aspect of the invention, the vehicle license number of the seller. In this manner, the potential purchaser need only enter in the license plate number of the seller (which is easily visible to any potential purchaser who is following the seller's car) into the space provided by the entry template illustrated in FIG. 2 to activate the various features of the present invention. Alternatively, the license plate number may also be broadcast by the seller, in accordance with the automated URL(s) entry feature described above, and may be automatically entered into the purchaser's iphone(s).

When the potential purchaser submits the car registration number or URL(s) to the system by entering in the data and pressing the appropriate buttons on the iphone(s), the software and hardware of the system may cooperate to calculate a packet size associated with the information that the potential purchaser has requested. If this packet size exceeds the limits of the memory of the buyer's iphone(s), a warning may be provided to the buyer and a prompt will be presented to the buyer suggesting that the buyer modify or re-enter any search criteria that may further limit the amount of information that would need to be downloaded into the potential purchaser's phone. This feature of the system would avoid those cases where the potential purchaser's phone would not be able to process all of the information provided to it by the system, and thus would avoid any unnecessary charges to the potential purchaser for connect time or data transmission by the purchaser's telecommunication company. If the packet size of the information about to be downloaded does not exceed the limits of the memory of the purchaser's iphone(s), the system may download the information. This download may, at the viewer's choice, include all of the information contained on the web site, or may only include a few web pages at a time so as not to exceed a predetermined portion of the memory of the iphone(s). In most cases, this information comprises a list of goods or services for purchase. At the end of this download, the iphone(s) display may indicate the size of the download and the cost of the download that will be billed to the purchaser.

If the potential purchaser finds any interesting items for which the purchaser wants to negotiate with the seller, the viewer may then click on a symbol, such as “ring for negotiation” or “ring for NEGO” which is interpreted by the software in the iphone(s) and the system to send an email to the seller's iphone(s) indicating that a potential purchaser wishes to negotiate for a particular item, and causes the seller's iphone(s) to ring, or otherwise notify the seller that a potential purchaser wishes to negotiate. Alternatively, the iphone(s) may be capable of being contacted by the purchaser without utilizing the email function of the iphone(s). For example, the software and hardware of the present invention may be capable of sending a signal to the iphone(s) that causes the iphone(s) to beep, or otherwise notify the iphone user that communication with the user is desired. This feature may also be included as part of the broadcast function described above.

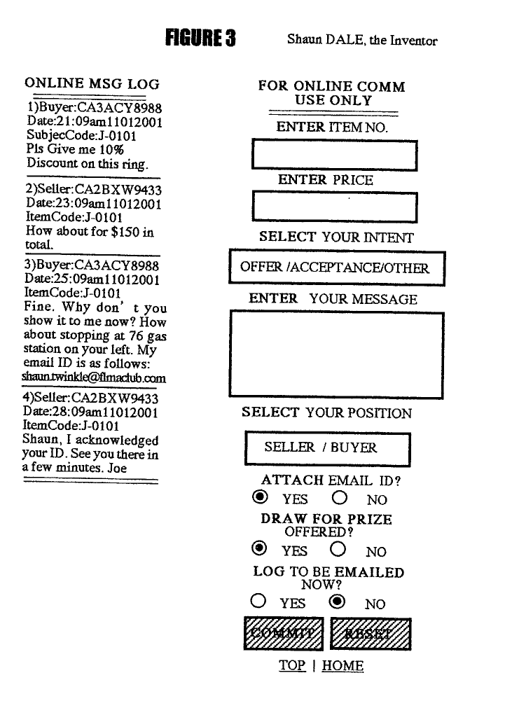

As illustrated in FIG. 3, once the seller is alerted that a potential buyer wishes to negotiate for an item, the potential purchaser is presented with a display on his iphone(s) such as that illustrated in FIG. 3. As shown in this display, the potential purchaser may now enter in information, such as the price the buyer wishes to pay for the goods or service, along other information such as, quantity, color or type of items to be purchased. When the “commit button” is activated by the potential purchaser, the purchaser's iphone(s) sends the message to the seller's iphone(s). When the message is received by the seller's iphone(s), the message may cause the iphone(s) to alert the seller in some manner. If the iphone(s) alerts the seller, the seller may then activate the appropriate key or button to cause the message to be displayed on the iphone(s). Alternatively, the message may be automatically displayed on the seller's iphone(s). If the seller agrees to the price offered by the purchaser, the seller may then use the iphone(s) to notify the buyer that he accepts the buyer's price or to send a message containing a counteroffer. Eventually, it is anticipated that the seller and purchaser will reach a mutual agreement as to the price or other feature of the item that is under negotiation, and that a purchase will be completed.

Another feature of the method of the present invention contemplates that the seller may offer a further incentive to the potential purchaser in the form of entry into an online bingo or keno game or other promotional drawing system, depending on the legality of such systems in the area within which businesses being carried out. The present invention also includes methods for ascertaining whether the buyer has qualified to be offered a chance at winning the promotional draw. For example, if the seller offers the purchaser a bingo draw for a prize, on a per sale basis, or the advertiser offers the viewer the same bingo draw on a per view of the advertiser's ads basis, there must be some means to ascertain that in fact the seller has sold the seller's goods and/or services to the purchaser, or the viewer in fact viewed the advertisements. Without either a sale or a view of the ads, the bingo draw may be determined to be illegal gambling under applicable laws, and not the intended sales promotional drawing system or promotional drawing system contemplated.

The present invention contemplates that in the case of a per sale basis of goods or services, the system of the present invention may be to record or log all of the online negotiations taking place in the process leading up to the consummation of each sale or purchase to produce evidence that in fact the sale was consummated, and/or in addition to require the parties presence upon the consummation and initiation of the promotional drawing system depending upon the laws and regulations applicable in the area. This invention also contemplates that in case of the per view basis of advertisements, the system of the invention may be configured, for example, to request the viewer to answer questions that depend upon the viewer locating hidden key words scattered throughout the advertisement in question and/or hard to find passwords or numbers. Such questions may also be such that they cannot be answered unless the viewer actually reads all the ad contents of the advertisements. These screening methods may also be used in various combinations.

As soon as the purchaser is qualified to participate in the promotion, the purchaser may enter his favorite combination of numbers or letters and register the combination number on the web site, requesting that the seller confirm the registration and start the drawing. The purchaser then waits for the results of the drawing by the system. In the event that the buyer wins the drawing, the seller is obligated to give away the prize that the seller committed to the buyer.

An additional aspect of the present invention is the ability to use the capabilities of the iphone(s) and its connections with the Internet to form online communities of individuals having common characteristics in fractal fashion. The system of the present invention allows the online communities to be provided with goods and services by sellers who are willing to provide the goods and services at discount prices to the members or the MBRs of the online community.

A novel aspect of this embodiment of the present invention is the method of advertising the availability of the online community and for registering new members or providers of goods and services with the Internet community. The resulting fractal organization is an important aspect of the present invention.

For example, gas stations may be the perfect group of businesses to become involved in the online community called FLMACAR.COM as the SECOND GROUP (or “FC GROUP”) who may provide some benefits such as discount benefits to the FIRST GROUP (or “MBRs”). This community may be conceived as a UNIT consisting of an operator of .FLMACAR.COM or the HOST SERVER, the FIRST GROUP or the MBRs, and the SECOND GROUP or the FC GROUP. In this Unit or community, all elements of the community enjoy benefits. The MBRs may enjoy benefits such as free web site hosting and email services or other benefits such as commissions provided by the HOST SERVER when the MBRs recruit new members into the SECOND GROUP or the FC GROUP. The SECOND GROUP or the FC GROUP may also enjoy web and email services provided by the HOST SERVER at a nominal fee such as, for example, $5.00 per month, as well as increased sales created by the MBR customers.

With the substantial commissions offered by the HOST SERVER to the MBRs who recruit new FC GROUP members, the MBRs are motivated to promote various entities, for instance, gas stations that would bring some benefits such as discounts to the MBRs, to participate with the FLMACAR.COM community. These gas stations have no reason to refuse such participation as the increased number of the MBRs customers would contribute to the FC GROUP's gasoline sales. Consequently, this community would grow organically without the need for employing costly outside sales personnel.

In addition, the fractal aspect of the present invention allows one of the FC GROUP members, for example, 76LAX gas station, to become a SECOND LEVEL HOST SERVER, and operate a w_w.76LAX.FLMACAR.COM community dependently or independently. This SECOND LEVEL HOST SERVER (76LAX Gas Station) may also offer benefits such as free web and email services to all the customers of the 76LAX gas station (hereinafter referred to as the SECOND LEVEL MBRs) whenever they come to their stations to fill up their cars. This SECOND LEVEL HOST SERVER may also offer, at a nominal fee, web and email services to those non-competing groups of individuals and/or businesses with the SECOND LEVEL SERVER's original business, such as DRIVE-IN RESTAURANTS (for example “DALE'S”), as the SECOND LEVEL FC GROUP who would offer benefits such as discounts to the SECOND LEVEL MBRs.

The SECOND LEVEL FC GROUP in turn will enjoy the benefits associated with the increased number of the SECOND LEVEL MBR customers, in addition to the MBRs of the FIRST LEVEL.

It is entirely possible to repeat the fractal method of the present invention by putting the SECOND LEVEL FC GROUP into the shoes of the HOST SERVER such that the SECOND LEVEL FC GROUP may become a THIRD LEVEL HOST SERVER and organize a w_w.DALES.76LAX.FLMACAR.COM community and so on.

For another example, the present invention provides a site for use by airline crew members. This web site may be for the HOST SERVER, hosting crew member web sites and enabling crew members who are members of the web site to have email addresses incorporating the web site address. To make the URL(s) of the site easily remembered by the members of the site, the site may have a name such as w_w.CrewMbrs.Com and the like. This concept may be extended to other groups of individuals with common characteristics, such as university students whose URL(s), could employ the common term “USA” wherein “USA” stands for University Student Association.

In the past one difficulty in recruiting advertisers and others who would wish to have web sites hosted by the server of the present system is that a provider of such services typically must use a sales force to go out and recruit shops and members into the system. The present invention, however, addresses this disadvantage, in that the present invention does not require an outside sales person to recruit new members or new shops or service providers into the system; and rather, the present invention utilizes members of the system as sales agents and provides those members with an incentive to recruit new members and new providers of goods and services into the system as briefly explained above.

As an illustration, exemplary relevant procedures in the workings of the recruitment process, and the benefits offered, are recited in detail below for w_w.JL_Crew.MbrOnly.com (the jl_crew member web site). First, a crew member of an airline who wishes to become a member of the community called JL_Crew.MbrOnly.Com (or the HOST SERVER) would be charged nothing or a nominal fee for the new member (the FIRST GROUP or the MBRs) to open a home page and to be provided an email address such as newname@jl_crew.mbronly.com.”

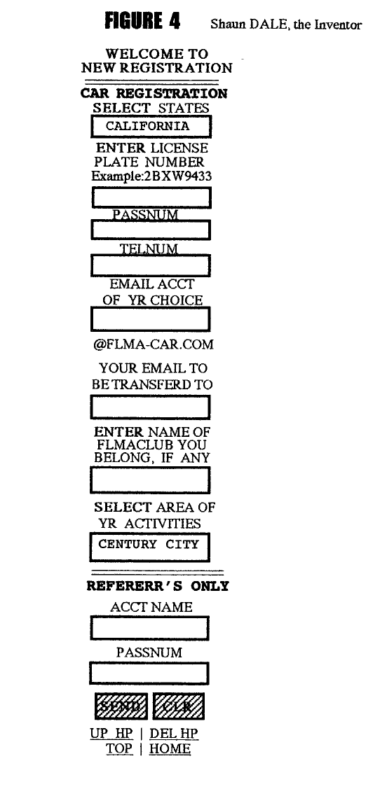

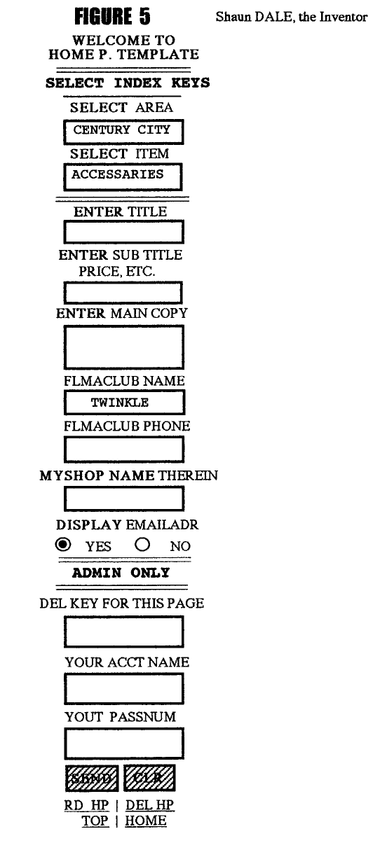

The new member (or the MBRs) may also be granted the right to recruit other new members into the web site who would enjoy the same priviledges. This recruitment may be facilitated by providing the new member with software that can be downloaded into his iphone(s) when the new member logs onto the member web site. This software may serve several purposes. In one aspect, the software may include the ability to show potential new members sample advertisements, including available discounts from providers of goods and services utilizing the system. When recruiting new members, the software may be used to provide the member attempting to recruit to the new member with the ability to register new members using an instant registration feature. The software may also allow new members to create and upload content for their home pages in just a few minutes. To accomplish this home page creation, the upload feature of the software may include simplified templates so that any new member, even persons who have never used a personal computer or an iphone(s) previously, could register their accounts and upload their home pages in a brief period of time. Examples of the display screens that may be presented to new user allowing instant registration and uploading of new web pages are depicted in FIGS. 4 and 5.

The method of the present invention for doing business on the Internet also includes the feature of offering commissions to members to recruit new advertisers and providers of goods and services (or the SECOND GROUP or the FC GROUP) into the system. The software available on the system that may be downloaded into the user's iphone allows the member to walk into a place of business and make an instant presentation of advertising possibilities to a potential advertiser or provider of goods and services. Moreover, since the ads are focused to a particular group of individuals having common characteristics, it is possible for advertisers to target their advertising specifically for particular goods and services, and even to offer discounts to particular groups of people that would not be available to persons not affiliated with the group.

For example, many hotels and rent-a-car agencies and restaurants (the FC GROUP) offer large discounts to airline personnel. Using the software embodied in the present invention, a member of a particular airline member group, such as jl_crew.rnbrsonly.com (the MBRs), may be offered discounts by particular advertisers and providers of goods and services. One advantage of the present invention is that the software of the present invention allows members to access all of the ads of providers of goods and services through use of the iphone(s), along with the capability of viewing available discount rates. However, other advertisers and providers of goods and services, because they lack the proper log on name and codes that allow viewing of all information, are restricted from seeing the discount prices offered by competitive providers of goods and services. Thus, members logging on to the system using particular log on names and passwords are able to shop among all available advertisers and providers of goods and services and compare available discount rates offered for those goods and services, but such discount rates would not be viewable by advertisers browsing the web sites.

Similarly, the system may provide security software which allows only members of a particular group may view particular discounts targeted to the particular group. In this manner, members of various groups may be presented with different discount rates. The advantage of this system is that it would allow advertisers to target particular groups of individuals having certain characteristics that were of interest to the advertiser.

A further advantage of the system of the present invention described above is that the system allows members to recruit and upload ads of shops who wish to participate in the program with little effort and expenditure of time, thus avoiding the large expenditures for overhead typical of marketing and merchandising advertising campaigns.

Moreover, with the instant upload feature of the present invention, the advertiser may upload, delete, or modify their ads in a brief period of time at any time from anywhere in the world that provides service for an iphone(s). Thus, the ads could be modified or deleted as the advertiser desires. Typical input screens used to register and upload new advertisers or discount shop owners into the system are presented in the attached figures.

As described previously, the member shops may also offer users of the system the ability to win a prize using an online keno or bingo or other gaming system. Moreover, particularly in the case of restaurants, users of the system may be able to make reservations for meals online using their iphone(s).

In another embodiment of the present invention, the invention provides a NEW 3 DIMENSIONAL ASSESSMENT CONCEPT to evaluate all the resources which are to this date evaluated only 2 dimensionally. Under this concept, the third dimensional element (time) is taken into account in evaluating resources (including human resources), in addition to the 2 dimensional evaluation practices of the art.

For example, a one acre Shopping center Parking lot used between 10:00 am to 10:00 pm for 12 hours only per day is currently assessed 2 dimensionally (without taking the time element into consideration) to be worth a million dollars can be assessed 3 dimensionally at a value of 2 million dollars, as another 12 hours of productive utilization between 10:00 pm to 10:00 am next morning should produce a doubling of the returns available based upon the current 12 hour usage. If this way of evaluation and concomitant hourly division of the ownership of the parking lot should be admitted legally and accepted by the Capitalism in the free world, the ownership of the parking lot between 10:00 pm and 10:00 am next morning may be traded and utilized productively by other creative entities such as HOST SERVERs of FRACTAL ORGANIZATION herein contemplated, consequently assuring the increase of the additional one million dollars value to the parking lot.

This Concept, if admitted and employed by all the governments in the world, will result in all resources available on earth being more productively utilized than otherwise, and consequently contribute to accommodating more population of mankind.

In the scope of proliferating this New Concept (hereinafter called SUPER CAPITALISM) throughout the world, this method may be actively employed in various businesses in very similar manners under the 2 dimensional assessment. In a further aspect of this embodiment of the present invention, the resources that may be considered to be used productively in the two-dimensional assessment method of the art but not considered to be productively used in the NEW THREE-DIMENSIONAL CONCEPT or assessment method or under the SUPER CAPITALISM may be converted into an asset that could be exchanged by an entity providing the system of the present invention for stock in the providing entity.

For example, a fixed percentage of seats on an airline flight might be deemed to be excess capacity and exchanged with a providing entity for stock in the entity. The entity would then be responsible for selling the seats. If the entity is successful, the value of the entity should increase, thus increasing the value of the stock received by the airline. Similarly, since all of the seats of the airline flight are serviced by the same airline personnel, the time devoted to servicing the excess seats by airline personnel may be compensated for by providing stock in the entity to the airline personnel.

This embodiment would allow, for instance, the HOST SERVER of the w_w.CrewMbrs.Com community to form the FC GROUP called w_w.UnitedAirlinesSystems.CrewMbrs.Com which would eventually acquire all the excessive seats of all the airlines in the world and provide such seats to the MBRs of the Crew_Mbrs.Com community and/or the MBRs of all the participating entities of the FRACTAL ORGANIZATION at a less expensive fare basis such as at 10% of normal economy fare plus, for example, restricted terms and conditions. Such terms and conditions may be with a Stand-By basis or a space available basis, for instance, as of 10 minutes prior to departure, with a no-check-in baggage requirement and with a proper attire requirement, so that any available seats, even in the first class section may be allocated to the use of the MBRs by the participating airlines with the URL(s) All the status and requirements of all the available seats of all the flights may be processed and provided real time by the use of the INSTANT UPLOAD, REGISTRATION and COMMUNICATION features of the present invention with the iphones of the MBRs wherever and whenever they may be, making possible such tight restrictions. By this method, already enforced SOPs or Standard Operational Procedures of the participating airlines may be kept intact, and may allow the participating airlines to sell all the seats including those seats belonging to w_w.UnitedAirlinesSystems.CrewMbrs.Com to the public until last minute before departure of a given flight.

Another example of such a system is the use of excess space in the cafeteria or restaurant of an airport. During off-peak hours, it is typical for sections of an airport restaurant to be closed off because there is not enough customer flow to justify keeping the entire restaurant open, along with providing the appropriate amount of staff support to ensure that customers sitting at all tables are serviced properly. Using the modified business method of the present invention, such excess space may be traded with the providing entity of such a system for the stock in the providing entity and/or for any other compensations agreeable to the owner of such a restaurant and dedicated to the use by, for example, the MBRs of the HOST SERVER w_w.CrewMbrs.Com Accordingly, one part of a restaurant, or store could be productively utilized for use by the MBRs between the hours of 2 P.M. to 5 P.M. During this time, the restaurant would partition off the dedicated space, perhaps by hanging signs or roping the area off identifying the area as for crew members only.

Additionally, a special menu could be offered within that reserved section, which could be made available for display on the iphones of the MBRs of w_w.CrewMbrs.Com so that those members would be able to see what was being offered. Further, use of an iphone(s) to review the menu offered in the dedicated space of the restaurant may also allow the iphone user to order the food they would like to purchase online and provide the restaurant with a time at when they would present themselves. Thus, a member of w_w.CrewMbrs.Com, using his or her iphone(s), could reserve a seat in the restaurant and order their entire meal while on their way to the restaurant. The meal would be waiting for them when they arrived at the airport restaurant, thus eliminating unnecessary delay, which would be particularly advantageous to airline crew members with tight connections between flights.

It will be obvious to those skilled in the art that the same services and goods may be offered to members of other clubs, such as, airline passengers who are club members. It will also be apparent that the above-identified method of doing business is applicable to many providers of goods and services and is not limited to restaurants.

For example, with regard to the previously described method for providing an online negotiation process to buyers and sellers of goods, a seller who has limited room in his or her vehicle for storing an inventory of merchandise may be able to contract with a shop or other facility with excess space. In this manner, shops or facilities with excess space that wish to engage in providing such access services to those who would utilize it, could advertise the availability of such space on the member web pages that are accessible through the iphone(s).

Such FleaMaClubs may offer to rent each of thousands of boxes or wardrobes in various sizes installed in excess space one by one or even hanger by hanger of such wardrobes and the like. These operations are elaborated in detail hereinafter.

Operations, including flea market operations, for goods including commodities, animals, fish, plants and the like, and any services may be conducted by and between those members who utilize otherwise unused space, including vacant premises and/or any establishments with excess space such as shops, restaurants, gas stations, hotels, home centers, even parking lots, vacant lots, and areas bordering, or on, bodies of water, such as seashores, lakes and the like.

Said FleaMaClubs may partition off a corner or a part or all of their premises or space for any operations, such as the aforementioned flea market, installing boxes, shelves, showcases, wardrobes, cabinets and/or marking and allocating a space on the land and/or the water in various sizes including parking lots, any under-utilized area on lakes or other bodies of water, underground storage areas and/or in the air or even in space, either real or virtual, and lease, rent, or let them, at a reasonable cost ranging from a few cents per square or cubic foot on up, and/or on a consignment basis, and/or on a flat- or negotiated-fee basis, and/or applying the SUPER CAPITALISM concept of this invention as heretofore described, and have various individuals or entities, including housewives, students, full- or part-time workers and the like, and/or entities, who need such additional space and/or who desire to open their own shops or businesses, or to enhance their existing shops or businesses, utilizing such an allocated space(s) in order to market, distribute, offer goods and services at all times or any under-utilized portion of the time.

Members of FleaMaClubs may bring their allotted space(s), their own goods for sale, rent and/or other business or non-business purposes, including giveaways or charity purposes and the like, and may display those goods and/or offer anything for sale, lease or rent, including services of any kind, and may attach their own signs to their allotted space(s), hang pop cards, price tags, etc. and, most importantly, utilize the URL(s) of their web sites, allowing them to conduct intended businesses and services. On the members' and FleaMaClubs' web sites, listings of a part or all of the goods displayed and/or of leads displayed for services may be advertised as a promotional means by the FleaMaClubs for their members.

Furthermore, each item of such listing may be linked to corresponding members' and/or corresponding items' web sites, providing detailed specifications with or without photos, video images, either still or in motion and/or audio explanation of any related information for the benefit of interested persons. Such features allow consumers to find relevant information on the items in which they are interested directly from individual business owners' and/or sellers' web sites in real time immediately via their iphone(s)—or any computer (s) installed in the FleaMaClub for customers thereof.

Furthermore, if any negotiations with individual businesses or individuals are necessary, consumers may avail themselves of the online negotiation feature of this invention, either voice- or data-based, and maintain logs of the legal aspects of the negotiation and sales processes, such as offer and acceptance through consummation of any deals, which can be produced to the parties involved upon request at any time.

Furthermore, consumers may draw online or offline for prizes or other rewards in real time and may do so, if desired, in the presence of any person whose presence as a witness or otherwise may be required by law or business necessity.

With this method, it will be possible for one person to operate thousands of individual shops or businesses independently within said FleaMaClub, as no personnel are required to have any knowledge of commodities or services offered, allowing nearly automated retail shop operations. Furthermore, since these operations can be automated as heretofore explained, FleaMaClubs may be operated without any shopkeepers or other personnel, allowing shoppers to pay online and release specified businesses to commodities by remote control, as described in the Mobile Camera operations, depending only upon the security situation and/or the social environment, allowing as few as a single central station to manage all of the participating FleaMaClubs by utilizing the online video and/or security features of this invention.

Furthermore, by assigning URL(s) not only to each box or to each hanger, but also to each commodity, whether a commodity is an inanimate object or living forms such as animals, plants, fish and the like, it will become easier than ever for a shopper to access his, her or its corresponding web sites and retrieve detailed information therefrom. This feature allows for thousands of members of the FleaMaClub to open their own business with only a small investment and without requiring their physical presence at their corresponding space or shops, leaving all the sales transactions to a shopkeeper(s) of the FleaMaClub, based upon a negotiated fee arrangement.

Additionally, the aforedescribed assignment method of URL(s) allows another novel business aspect involving various human interactions and/or businesses.

For example, if a person who himself gets a similar URL(s), wears a badge indicating said URL(s) and goes to a public or private event where business people gather, he may encounter a prospective employer who, by accessing his URL(s) and checking his credentials by anonymously accessing his web site, becomes interested in employing that person.

For another example, a single person who wants a companion may join as a member with the online community called w_w.CQmate.Com, attach a URL(s) strapped to their person and go to a public location such as a hotel, train station, air terminal or the like, thereby allowing interested persons to anonymously access his or her web site and check his or her background to determine whether or not to pursue a personal relationship.

For another example, a member of w_w.CQrides.Com or w_w.CQlocals.Com online community may arrive on, say, a United Airline flight at LAX from London. If this member wishes to go to a local destination in, say, Hollywood, he may be able to locate a car with a decal of URL(s) attached to the bumper of a vehicle, enter its car license plate number to his iphone(s) to anonymously access its web site to see if its destination and en-route information, as well as its driver, should fit in with his intention and tastes. After having checked the provided information, the member can make an informed decision to accept a ride or not.

In a further embodiment of the present invention, a novel system of advertising can be accomplished utilizing email addresses that can be entered into the iphone for electronic correspondence. As was described previously, participants in the business method of the present invention may be registered with the system and obtain unique URL(s)'s such as Under this HOST SERVER, or an operator of the Crew_Mbrs.Com, its member or the MBRs of Crew_Mbrs.Com could obtain an email address in the form of “An extension is possible as previously described and may be likened to fractal geometrical growth.” By this it is meant that the Crew_Mbrs.Com web site could offer to a hotel or rental car or other income-generating entities as the FC GROUP, allowing to use, for example, SURFRIDERHOTEL.crew_mbrs.com and an email of surfriderhotel@crew_mbrs.com and this FC GROUP may later become the SECOND LEVEL HOST SERVER, taking the same URL SURFRIDERHOTEL.crew_mbrs.com and operate the online community, offering its guests an email of “guestname@surfriderhotel.crew_mbrs.com or “guestname.surfriderhotel@crew_mbrs.com”.

Furthermore, the SURFRIDER HOTEL could offer for a nominal fee, the web site space to, for example, a Rent-a-Car Agency, as the SECOND LEVEL FC GROUP that would benefit the SECOND LEVEL MBRs (the hotel guests), offering some sort of benefits such as discount benefits or a free ride during certain hours, etc., to them, allowing the use of a URL such as “RENTACARAGENCY.surfridershotel.crew_mbrs.com.”

This SECOND LEVEL FC GROUP may become the THIRD LEVEL HOST SERVER later and operate the online community called RENTACARAGENCY.surfriderhotel.crew_mbrs.com and offer its customers or the THIRD LEVEL MBRs, an email address such as “rentacarguestname@RENTACARAGENCY.surfridershotel.crew_mbrs.com” or “rentacarguestname.RENTACARAGENCY.surfridershotel@crew_mbrs.com”.

Additionally, this THIRD LEVEL HOST SERVER may recruit another THIRD LEVEL F-C GROUP in other non-competing businesses or industries such as Night Clubs, Tour Guides et al., and allow them to use a URL such as “NITECLUB.rentacaragency.surfriderhotel.crew_mbrs.com” and to receive emails from their customers or MBRs, “niteclub-clientname@NITECLUB.rentacaragency.surfridershotel.crew_mbrs.com,” “niteclub-clientname.niteclub.rentacaragency.surfridershotel@crewmbrs.com,” and so on. Thus, the guests at the hotel and/or the customers of the rent a car agency and/or the clientele of the Night Club participants in the present invention could engage in electronic commerce utilizing the URL to host web pages and to have email addresses containing the URL of all the providers or the HOST SERVERs.

All such web sites and email addresses would be accessible using the iphone(s) as described above. Such unique email addresses are advantageous in that the providers of the service, in this case crew_mbrs.com or surfriderhotel, rentacar agency, and niteclub, receive free advertising each time the URL or email addresses is used by another person. Offering free WEB AND EMAIL SERVICES to their guests or customers itself is also advantageous to the hotel or car rental agency or other entities in that users of this system may be more likely to repeat as customers of the hotel and/or other participating entities.

It will be obvious to those skilled in the art that such a system applies not only to hotels or car rental agencies, but applies equally to any entity generating income from advertising based commerce, such as gas stations, drive-in restaurants, night clubs, and the like. In keeping with the fractal nature of this business model, it is anticipated that additional levels of participation could be carried out on and on and on. One disadvantage of this method is, however, that the URL(s) and email addresses may become long and unwieldy and difficult to enter as more levels are added to the URL(s) to promote additional advertisers. This disadvantage may be overcome by utilizing the URL BROADCAST, RECEPTION, and RECOGNITION aspect of the present invention described above.

Another embodiment of the present invention utilizes a camera attached to the iphone(s) such as an iphone camera 106 in FIG. 1 that is capable of taking either still pictures or video and transmitting the pictures or video through the iphone camera 106 and Internet to servers configured to receive the transmitted images. The iphone camera 106 may also be configured to use the camera to capture images of URL(s) displayed on clothing, vehicles, billboards or the like, and, using specialized software in the iphone camera 106, enter the URL(s) into the iphone camera 106 so that it can be used to access the web page identified by the URL(s).

A camera and iphone combination and the like (“iphone-camera”) also provides the opportunity to create an on-line community like w_w.Mobile_Carnera.Com or w_w.MblCam.Com. This HOST SERVER may take all the people who own such an iphone-camera as the MBRs, offering free web and email services or for a fee and the like and/or buying their iphone-camera assets under the SUPER CAPITALISM concept in exchange for the stocks of the HOST SERVER, and take photographers or other persons and/or entities such as Press, TV media, Publishers et al. who would desire to obtain photographs remotely as the FC GROUP, offering free web and email services or for a fee and the like. Thus, the HOST SERVER w_w.Mobile_Camera.Com or w_w.MblCam.Com may start a new FRACTAL ORGANIZATION.

As described above, various methods may be used to recruit iphone-camera owners to provide such photographs or videos, including recruiting them into the MBRs of the w_w.Mobile_Camera.Com or w_w.MbiCam.Com as described above using the instant registration feature described above. Additionally, the iphone-camera(s) of the members or the MBRs of w_w.Mobile_Camera.Com or w_w.MblCam.Com may include a G.P.S. receiver capable of providing a signal to the iphone-camera(s) that may be transmitted through the Internet to the w_w.Mobile_Camera.Com or w_w.MblCam.Com web server. In this way, the HOST SERVER would be aware of the location of the MBRs, so that the HOST SERVER as well as the FC GROUP can easily locate the MBRs and request the MBR's assistance of the FC GROUP's choice to take photos or videos of particular locations as needed. The MBRs could be contacted by all the MBRs and the members of all the participating FC groups, using the real time communication feature of the iphone-camera(s) to exchange any forms of the messages to and from between the parties concerned. A fee may be paid by the FC GROUP member to iphone-camera owners or the MBRs, for assistance, including photo taking so that the photograph or video would be a work made for hire. In this manner the copyright for the photo or video would belong to the FC GROUP member or the operator engaging the remote photo taker.

Since not many photographers who would be satisfied with such work for hire; the present invention contemplates another embodiment which includes configuring the iphone-camera(s) so that the attached-camera(s) may be remotely controlled by the FC GROUP (photographers et al.).

In this embodiment, as long as the MBRs who own the iphone-camera agree to assist the FC GROUP member shooter(s) and physically move them or iphone-camera(s) to the shooting location(s), the FC GROUP member(s) can use the iphone-camera(s) at will, allowing the FC GROUP member shooter(s) to decide a shooting timing and/or switching timing of participating iphone camera(s), by watching the images coming in over the Internet, controlling, for example the focus, shutter speed or panning and zooming, etc. and shooting of all the iphone camera(s), by pressing the control button(s) including the shutter button(s) which are displayed on the screen of all the iphone-camera(s) or equipped therewith and the like, for a shot(s), thus insuring the FC GROUP member shooter(s) the shooter(s)' genuine copyright(s) on the work. These operations will require cooperation between all the elements and subjects of Mobile_Camera.Com online community throughout the world, and therefore, the fractal nature of the organization and the SUPER CAPITALISM concept contemplated in the present invention would be important to provide such constructive remote-shooting services inexpensively to the interested parties or to the MBRs.

The following are other examples of how the fractal organization method of the present invention may be used to establish and organize various groups to maximize the utility of the group to its members and potential advertisers or providers of goods and services.

For example, the w_w.CQjobs.com online community may accept Job Hunters or unemployed persons as the MBRs, and may recruit Head Hunters as MBRS of the FC GROUP. Similarly, the w_w.CQgals.Com online community may recruit girls as the MBRs, and may also accept those men who are seeking matches as the FC GROUP or vice versa. The w_w.CamperPark.Com online community may recruit owners of motor homes, electric cars and the like as the MBRs, and could also take those shopping center parking lot owners and the like (10:00 pm thru 10:00 am next morning) under Super Capitalism who could provide less expensive hookup services as the FC GROUP.

Further examples include the w_w.ABC-Apartments.in-Kyoto.Com online community which may include residents of the ABC apartment complex as the MBRs and may recruit Delivery companies such as Pizza, Laundry, etc. who could offer discounts as the FC Group. The w_w.ABC_Hotel.In-Waikiki.Com online community may accept all the hotel guests of ABC hotel as the MBRs and may accept those hospitality industry member companies such as tour-companies, rentacar agencies, etc., who could benefit the MBRs as the FC GROUP. The w_w.REbrokers.On-Guami.Com online community may be formed from all the real estate brokers in Hawaii as the MBRs and any developers and/or entities who want to sell their properties as the FC GROUP.

The w_w.CustomerMbrs.Com online community may accept as members all people who want email addresses as the MBRs and take other entities who wish to incorporate their names in the address for the MBRs as the sponsor as the FC GROUP. For example, Miss Jane Doe, a customer of zzz company, or the MBR wishes to acquire an email address and ZZZ company, the FC GROUP, wishes to advertise its name and may offer to Miss Jane Doe the MBR a free email address as follows: “jane_doe@ZZZ.GuestMbrs.com” “jane_doe@ZZZ.VipMbrs.com” “jane_doe@ZZZ. GoldMbrs.com” or “jane_doe.ZZZ@GuestMbrs.com” “jane_doe.ZZZ@VipMbrs.com” “jane_doe.ZZZ@GoldMbrs.com”.

Moreover, celebrities, such as Michael Jackson, may wish to sell their names as the FC GROUP for MBRs, and thus email addresses may be constituted as follows: (1) if Jane Doe is a fan of Michael Jackson, she may receive an email address such as “jane doe@Michael_Jackson.s_fanclub.com”; (2) if both Jane Doe and ZZZ company are fans of Michael Jackson, an email address may be constituted as: “jane_doe@ZZZ.Michael_Jackson.s_fanclub.com” or “jane_doe.ZZZ.Michael_Jackson@s_fanclub.com;” (3) if Jane Doe and ZZZ company are his supporters, the email may take the form: “jane_doe@zzz.michael_Jackson.s_supporter.com” or “jane_doe.zzz.michael_Jackson@s_supporter.com”.

Similarly, if Mr. G Bush, making up an FC GROUP, wants to publicize his name to the MBRs, he may request his name to be incorporated anywhere in the URL and email address as follows: (1) If Jane Doe is his advocate: “jane_doe@G_BUSH.s_Advocate.Com” or “jane_doe@G_BUSH.s_Advocate.Com;” (2) If Jane Doe works with United Airlines, and both are Mr. Bush's advocates: “jane_doe@UnitedAirlines.G_BUSH.s_Adovocate.Com” or “jane_doe.UnitedAirlines.G_BUSH@s_Adovocate.Com”.

As should be apparent to one skilled in the art, whenever these URL(s) and email addresses may be used, associated GROUPS and/or individual MBRs would benefit. Other examples include a w_w.CQLoad.Com or w_w.CQTruck.Com online community which would accept all truck drivers as MBRs and also recruit trucking related companies as the FC GROUP or vice versa. The MBRs may be able to pick up more loadings, consequently both parties would benefit each other. A w_w.MblShops.Com or w_w.CQCarPool.Com online community may accept all car drivers as the MBRs and also recruit Auto manufacturers and/or auto industry members as the FC GROUP.

In w_w.FleaMaMall.Com, the FIRST LEVEL HOST SERVER online community can make, for instance, the BROADWAY Mall to be the SECOND LEVEL HOST SERVER and give it a name such as w_w.Broadway.FleaMaMall.Com which would recruit passers-by in the Broadway Mall as its SECOND LEVEL MBRs, offering free web and email services and take each shop on the Broadway mall as the SECOND LEVEL FC GROUP, requesting those shops to offer benefits such as discounts to the SECOND LEVEL MBRs, thus making those passers-by the clientele of the Broadway mall or the Broadway.w_w.FleaMaMall.Com community.

Furthermore, each shop or the SECOND LEVEL FC GROUP member (for instance, ABC store) can become the THIRD LEVEL HOST SERVER and create a w_w.ABC.Broadway.FleaMaMall.Com online community. This THIRD LEVEL HOST SERVER may accept the customers of ABC store as the THIRD LEVEL MBRs of the community, and also recruit purveyors and/or suppliers or other related businesses to ABC store as the THIRD LEVEL FC GROUP and so on. By recursively incorporating the FRACTAL ORGANIZATION concept and other concepts of the present invention, these online communities or ORGANIZATION would grow into many great huge online fractal ORGANIZATION and/or grow into great huge real communities and bring about mutual benefits to all the subjects concerned.

While several particular forms of the invention have been illustrated and described above, it will be apparent that various modifications can be made without departing from the spirit and scope of the invention. Accordingly, it is not intended that the invention be limited, except by the appended claims.

I claim:

1. A method of providing interactions between parties via a communication means utilizing Internet ready gears comprising the following:
a. assigning a web address consisting of a URL or an account name for a world wide web server to the parties,
b. attaching said web address to the parties;
c. entering said web addresses into said gears by the parties;
d. accessing and retrieving information on the communication means; and
e. establishing a contact with the parties, whereby said interactions will be provided.
